(19) United States
(12) Patent Application Publication
(10) Pub. No.: US 2012/0239430 A1
(43) Pub. Date: Sep. 20, 2012

(54) System and Method to Provide Metrics Regarding a Physician's Performance to Protocol and Real-Time Alerts When Performance Deviates

(75) Inventor: Charles Corfield, Boulder, CO (US)

(73) Assignee: NVOQ INCORPORATED, Boulder, CO (US)

(21) Appl. No.: 13/411,162

(22) Filed: Mar. 2, 2012

Related U.S. Application Data
(60) Provisional application No. 61/452,233, filed on Mar. 14, 2011.

(51) Int. Cl. G06Q 50/24

(52) U.S. Cl. 705/3

(57) ABSTRACT

A system is provided for generating a standardized record relating to a customer encounter. The standardized record is compared subsequently or in real/near-real time to at least one standard of care protocol. Deviations between the standardized record and the standard of care protocol are recorded. In some instances, an alert may be provided to the service provider that the standard of care protocol has not been satisfied while the customer encounter is on-going.

### CLAIM OF PRIORITY UNDER 35 U.S.C. §119

The present application claims priority to U.S. Provisional Patent Application Ser. No. 61/452,233, filed Mar. 14, 2011, which is incorporated herein by reference as if set out in full.

### CLAIM OF PRIORITY UNDER 35 U.S.C. §120

None.

### REFERENCE TO CO-PENDING APPLICATIONS FOR PATENT

None.

### BACKGROUND

1. Field

The technology of the present application relates generally to automatically reviewing a patient electronic health record and determining metrics regarding the same, and more specifically, to comparing the electronic health record to protocol standards to determine whether health care providers are following protocols as well as providing real-time or near real-time alerts to health care providers if certain protocol features are not performed.

2. Background

Medical malpractice occurs when a health care provider is negligent in the care provided to a patient. Negligence by the health care provider may be determined in some circumstances by the standard of care and regulations associated with the health care industry. Not following the standard of care or any associated regulations for the particular patient care will generally result in a finding that the health care provider was at a minimum deficient in the care and possibly liable for any damages resulting from the failure to follow the standard of care.

One difficulty for health care providers is that it is sometimes difficult to know all of the various standards of care relating to any particular patient encounter. In some patient encounters, a general standard of care regarding medical or psychological treatment may apply. Yet in other patient encounters, a specific standard of care regarding medical or psychological treatment may apply.

Generally, health care providers belong to groups. These groups may establish protocols, to ensure the health care providers provide the generally accepted standard of care for any particular patient encounter. While beneficial to provide a protocol for any particular patient encounter, the failure of any health care provider to adhere to the protocol provided by the group may be evidence of a failure to provide the standard of care for that particular patient encounter. Thus, providing protocols may be a double edged sword. While protecting the health care provider when the protocol is followed, perhaps implicating them when the protocol is not followed.

Many health care providers have begun using electronic health records to record patient encounters. Some solutions to the above noted issues include programming particular protocols into an electronic health record forcing the health care provider to follow a particular protocol for every patient encounter. However, these approaches are less than satisfactory for a number of reasons. One reason includes the inflexibility of hard programming a protocol into a system to dictate the patient encounter. Another reason includes the fact that many patient encounters are recorded in a medium other than the electronic health record at the time of the patient encounter. Thus, programming the protocol into the format associated with recording the electronic health record does not provide any feedback for the doctor during the patient encounter.

Thus, against the above background, it would be desirable to provide a system that allows a health care provider flexibility during the patient encounter. Moreover, if the health care provider does not record the patient encounter using an electronic health record, it would be desirable to provide a system that allows the development of the electronic health record following the health care provider's notes of the patient encounter and provide a metric regarding whether the health care provider, in fact, is following the established protocols of the practice group.

### SUMMARY

To attain the advantages, and in accordance with the purpose of the technology of the present application, a networked computer system may be provided. The networked computer system is configured to receive an electronic health record and fetch, from an associated memory, an associated protocol established by a health care provider. The electronic health record is compared to the protocol and deviations are noted.

In certain embodiments, the deviations from the protocols are reported to an administrator such that corrective actions can be taken. The corrective actions may be training, additional supervision, or termination of the health care provider that fails to complete electronic health records consistent with protocols. The deviations may be used to generate metrics regarding performance of the health care provider(s) to the standards and protocols established by a group of providers, hospital, or the like.

In certain embodiments, electronic health records that are associated with a loss to the provider group, which losses may be from a malpractice claim (whether or not liability is associated with the claim), incorrect submissions to the insurance company, or the like, are flagged for further analysis. The system analyzes the electronic health records associated with a loss to determine whether similarities or symmetries exist with the records. Those similarities and symmetries are noted and reported to an administrator. The administrator may update protocols and/or insert alerts and warnings into existing protocols to provide tips for health care providers to mitigate the loss risk.

### BRIEF DESCRIPTION OF THE DRAWINGS

A further understanding of the various embodiments of the present disclosure may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a functional block diagram of an exemplary system for determining whether a protocol is followed that is consistent with the technology of the present application;

FIG. 2 is a functional block diagram of an exemplary system for determining whether a protocol is followed that is consistent with the technology of the present application;

FIG. 3 is a functional block diagram illustrative of a methodology consistent with the technology of the present application;

FIG. 4 is a functional block diagram illustrative of a methodology consistent with the technology of the present application;

FIG. 4A is a functional block diagram illustrative of a methodology consistent with the technology of the present application;

FIG. 5 is a functional block diagram of an exemplary workstation or server consistent with the technology of the present application; and

FIG. 6 is a functional block diagram of a loss mitigation system consistent with the technology of the present application.

### DETAILED DESCRIPTION

The technology of the present patent application will now be explained with reference to various figures, tables, and the like. While the technology of the present application is described with respect to patient encounters with a health care provider, one of ordinary skill in the art would now recognize that the technology is applicable to other industries in which a provider may fail to provide an adequate standard of care or follow protocols including, for example, mechanics, building and construction, inspections, manufacturing, mining, chemicals, pharmaceuticals, transportation, and the like. Moreover, the technology of the present patent application will be described with reference to certain exemplary embodiments herein. The word “exemplary” is used herein to mean “serving as an example, instance, or illustration.” Any embodiment described herein as “exemplary” is not necessarily to be construed as preferred or advantageous over other embodiments absent a specific indication that such an embodiment is preferred or advantageous over other embodiments. Moreover, in certain instances only a single “exemplary” embodiment is provided. A single example is not necessarily to be construed as the only embodiment.

The detailed description includes specific details for the purpose of providing a thorough understanding of the technology of the present patent application. However, on reading the disclosure, it will be apparent to those skilled in the art that the technology of the present patent application may be practiced with or without these specific details. In some descriptions herein, generally understood structures and devices may be shown in block diagrams to aid in understanding the technology of the present patent application without obscuring the technology herein. The technology of the present application may be described with reference to particular discrete processors, modules, or parts, but one of ordinary skill in the art will recognize on reading the disclosure that processors may be integrated into a single processor or server, or separated into multiple processors or servers. Moreover, the technology of the present application will be described with reference to functionality and the functionality may be loaded onto a particular user's workstation (fat or thick client) or hosted by a server that is accessed by the workstation (thin client). In certain instances and examples herein, the term “coupled” or “in communication with” means connected using either a direct link or indirect data link as is generally understood in the art. Moreover, the connections may be wired or wireless, private or public networks, or the like.

In certain embodiments described herein, a customer or user, such as a patient, may visit a service provider, such as a health care provider, expecting a certain level of care. As identified above, in many situations, the encounter may need to conform to certain standards of care. Professional misconduct may occur from unreasonable skill of the service provider. Generally, malpractice is associated with services such as doctors, lawyers, and accountants. Failure of the person rendering the professional service to exercise the degree of skill and learning commonly applied under the circumstances by the average prudent reputable member of the profession, may result in the professional and the group employing the professional liable for damages that result from the service.

As mentioned above, the most widely known type of malpractice is medical malpractice. Medical malpractice results when there exists a physician's duty to a patient, there is an applicable standard of care that has been violated, there is an injury, and a connection between the violation of the standard of care and the injury. Often times, medical malpractice lawsuits arise when the result of the patient encounter is unsatisfactory to the patient or guardian. The only defense the health care provider frequently can employ is that the applicable standard of care was provided. Evidence of the standard of care and evidence that the health care provider followed and provided the applicable standard of care is often difficult to provide.

As will be explained further below, the technology of the present application will, in certain embodiments, document a health care provider's compliance with protocols and standards of care. Moreover, the technology of the present application will be able to flag electronic health records that resulted in a malpractice claim or other associated loss for the provider group or the like. The flagged records associated with losses would be analyzed by available tools to determine similarities between the losses and the electronic health records.

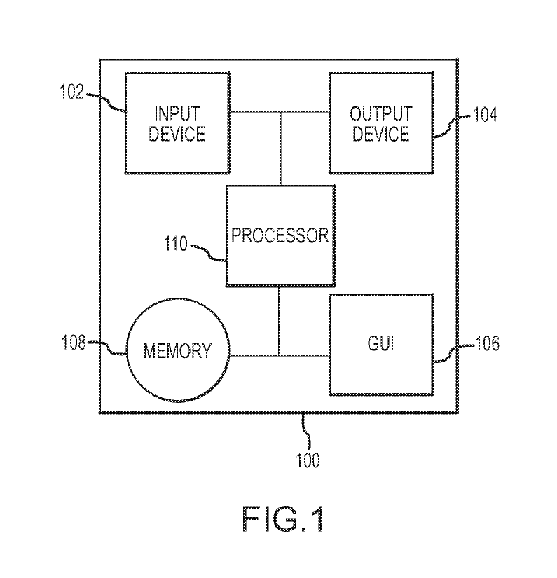

With regard to the above, we refer first to FIG. 1. FIG. 1 provides a workstation 100. The workstation 100, in this exemplary embodiment, is associated with a health care provider documenting a patient encounter. The workstation 100 may be a conventional laptop or desktop computer, server, or the like as is generally known in the art as well as other mobile devices such as cellular telephones, smart phones, tablet computing devices (such as the iPad@ available from Apple, Inc.), radios, and the like. In that regard, workstation 100 includes an input device 102, such as, for example, a keyboard, a light pen, a microphone, or the like, and an output device 104, such as, for example, a display, a speaker, or the like. The input device 102 and the output device 104 may include a graphical user interface 106, which may be combined for the input and output devices 102, 104. The workstation 100 also includes a memory 108 and a processor 110.

While only one workstation 100 is shown in FIG. 1, the technology of the present application may include a number of centralized or dispersed workstations that monitor patient encounters. Moreover, while described with specific reference to a patient encounter where the health care provider is in the same room as or in direct communication with the patient (such as in remote health care services using a robot and/or a video link), the technology of the present application also may be used to review other encounters such as, for example, on-line interactions between a customer and a provider using such technologies as on-line chats, text messages, other short message services, emails, or the like. In still other embodiments, voice conversations over a telephone or cellular network may be recorded as audio files that may be analyzed.

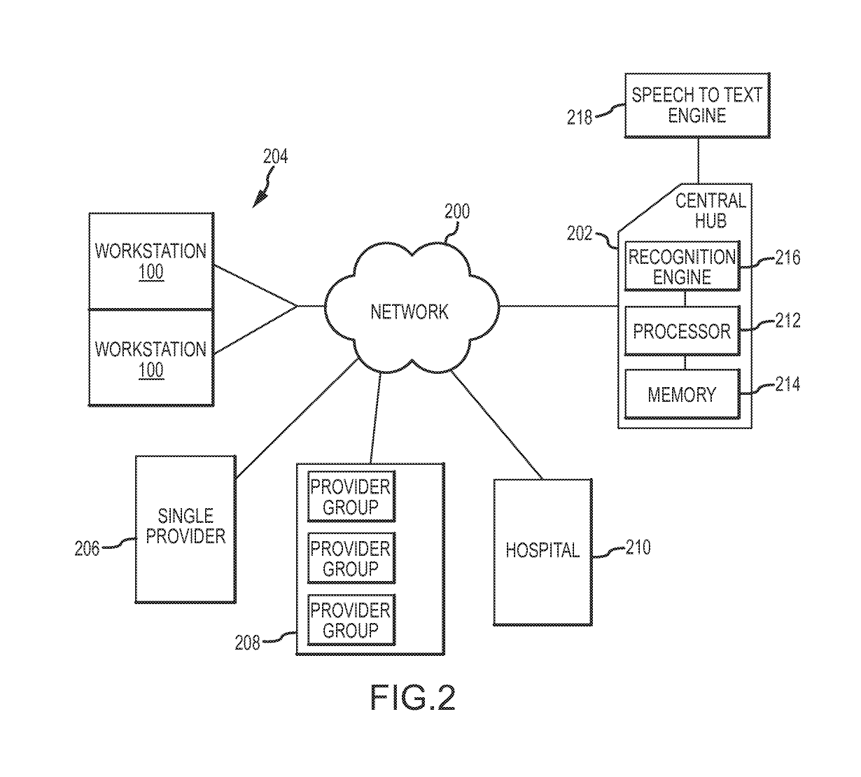

As shown in FIG. 2, one or more workstations 100 may be connected through a network 200 to a central hub 202. The central hub 202 would include, for example, a processor 212, a memory 214, and a recognition engine 216, which will be explained further below in connection with recognizing whether an electronic health record comports with established protocols. The recognition engine 216 optionally may include a speech recognition module to recognize audio, but recognition engine 216 is not limited to speech recognition. The network 200 may be a private network connecting, for example, a number of patient examination rooms or the like to the central hub 202, which may be a server dedicated to the particular health care practice or group of concern. Alternatively, or in combination with the above, the network 200 may include a publicly available network such as, for example a public switch telephone network (PSTN), the Internet, a WiFi network, a cellular network, cloud networking, or the like. The health care practice or group may be a provider group 204, a single provider 206, a cluster of provider groups 208, a hospital 210, or the like whether privately run, publicly run, or a combination thereof. If connected to a cluster of provider groups, central hub 202 may include one or more servers as required. Data sharing restrictions also would be required in view of health and privacy rules and regulations. Also, as will be explained further below, central hub may be connected to a speech to text engine 218. Speech to text engine 218 may be coupled to central hub, accessible over the network 200, or integrated into central hub 202, such as integrated into the recognition engine as identified above. Similarly, of course, lawyer, accountant, law firm, accounting firm, or the like may be substituted for health care provider, hospital, etc.

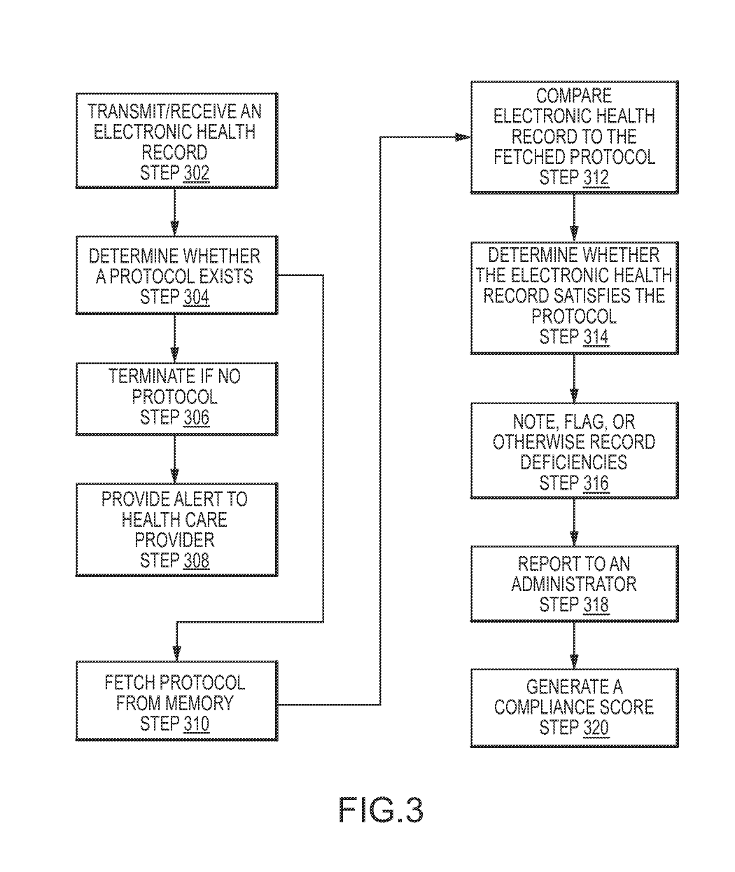

Referring now to FIG. 3, a flow chart 300 is provided with an exemplary method of receiving an electronic health record and comparing the electronic health record with patient notes using a doctor's dictation. While flowchart 300 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 300 starts when the electronic health record is transmitted to central hub 202, step 302. The electronic health record may be received in real time near real time, after a period of delay, before and/or after transcription by a transcription service as will be explained further below. Moreover, while explained in connection with an electronic health record, which is generally defined as a systematic, electronic collection of patient information developed during a patient/health care provider visit, (the concept of an electronic health record for purposes of the technology of the present application should be construed broadly to include other electronic communications between a patient and the health care provider. Thus, an electronic health record could be a recorded/transcribed telephone call, chats from a chat room type of encounter, text messages (or other short message service protocols), emails, blogs, or the like. The central hub 202 would review the electronic health record to determine whether a standard or protocol relating the patient encounter existed, step 304. The determination may be based on providing central hub 202 with information regarding the Current Procedural Terminology database (CPT) and the International Statistical Classification of Diseases and Related Health Problems database (ICD). While these two databases are generally used and approved in the United States, other databases may be used in other countries; moreover, the databases may change from time to time. For example, the CPT is currently managed by the American Medical Association and the ICD is managed by the World Health Organization. The recognition engine 216 may review the electronic health record for certain keywords and/or phrases and map the keywords and/or phrases to CPT and ICD diagnosis. The CPT and/or ICD diagnosis may be associated with a protocol or standard to which the health care provider should adhere. If the central hub 202 determines that a standard or a protocol for the recognized diagnosis does not exist, the procedure may terminate, step 306. As explained below, if the electronic health records are being processed in real or near real time, an alert that a protocol does not exist may be provided, step 308.

If recognition engine 216 determines a protocol exists, the protocol is fetched from memory 310. Recognition engine 216 compares the electronic health record to the protocol, step 312, again possibly using keywords and phrases or the like. Recognition engine 216 would determine whether the electronic health record satisfies the protocol, step 314. For example, the protocol may include steps requiring the patient's pulse, eye dilation response, temperature, etc. The recognition engine 216 determines whether the electronic health record contained either text related to the required information or entries in the appropriate data fields. Moreover, the recognition engine 216 may make a determination regarding whether the data is reasonable to identify likely errors or omissions. For example, a value of 112° F. (or 44.4° C.) for temperature would in most instances be flagged as not reasonable. The failure or omission of temperature may be flagged as a failure to order or perform a recommended or required test. In other words, the recognition engine 216 may determine whether vital signs or medical information relating to the electronic health record is within predetermined acceptable values or ranges. The errors or deficiencies may be noted, flagged, stored, or otherwise recorded, step 316. Optionally, the errors or deficiencies may be reported to an administrator, step 318. A score may next be calculated based on the comparison/determination, step 320. For example, a compliance percentage may be calculated determining the number of required protocol items that are satisfied. The score may be weighted to factor in higher priority items. For example, on a severe bleeding wound case, monitoring the blood pressure and pulse of the patient may be more important than checking, for example, oxygen levels of the blood.

Providing information, such as the above, provides multiple benefits. For example, a provider group may be able to determine the frequency and the severity in which a particular health care provider does or, perhaps more importantly, does not comply with the established protocols or standards. The provider group may elect to provide training or additional supervision to such a health care provider and/or terminate the same. Such measures would make it less likely the provider group would be found to have failed to provide the required standard of care.

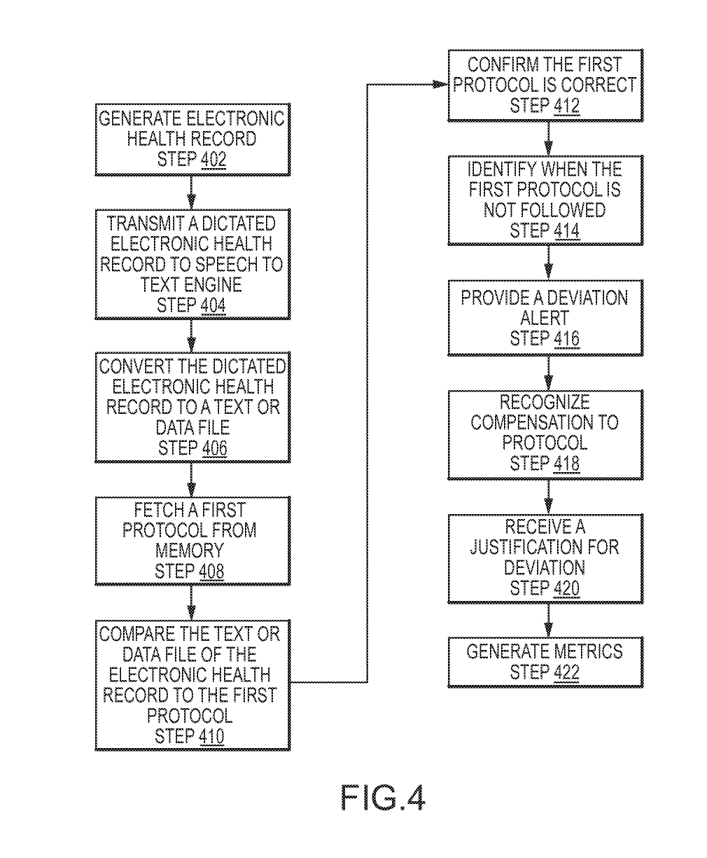

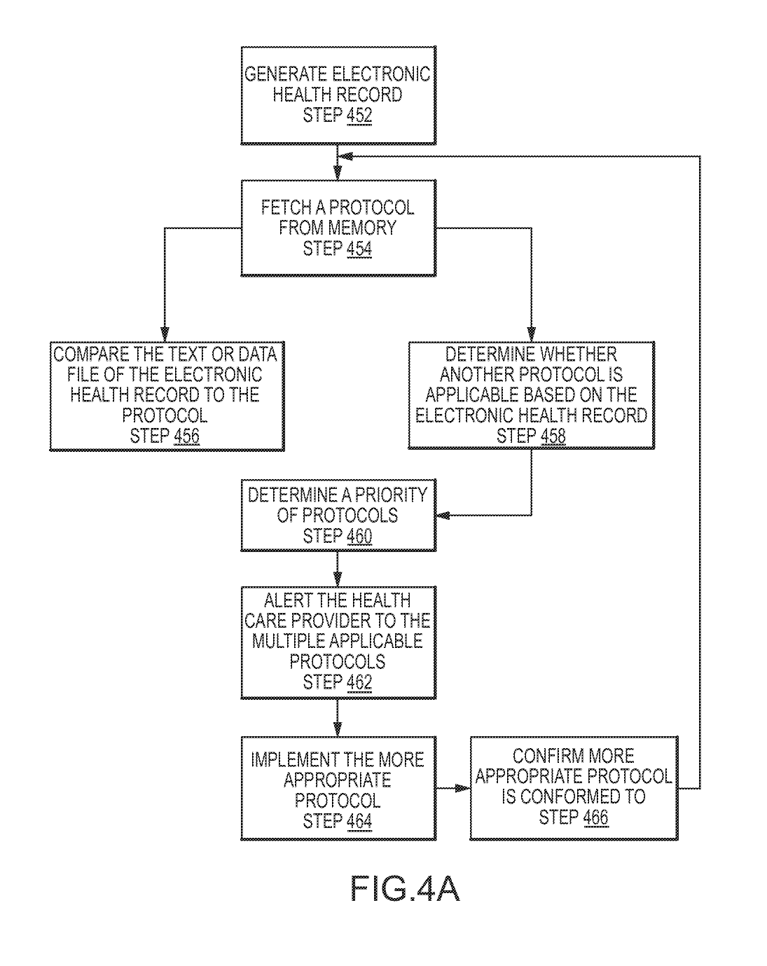

A health care provider, in some instances, may type, dictate, or otherwise input the patient encounter to the electronic health record at workstation 100. Creation of an electronic health record during the patient encounter may provide opportunities to alert the health care provider when a protocol is not being followed. Referring now to FIG. 4, a flow chart 400 is provided with an exemplary method of receiving an electronic health record and confirming in real or near real time the health care provider's compliance with protocols. While flowchart 400 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 400 starts with the generation of the electronic health record, step 402. The generation of the electronic health record may start with a doctor typing in notes to identified fields to generate the textual file containing data. Alternatively, the health care provider may dictate the patient encounter. Flowchart 400 describes a process in which the speech to text engine 218 converts audio files to textual files for processing, but the functionality described by the conversion is not required unless the process is a dictation based process. The audio file of the dictation is communicated to the speech to text engine 218, step 404. The audio file may be streamed, batched, or otherwise transmitted to the speech to text engine 218. The speech to text engine converts the audio file to a textual file representative of the electronic health record, step 406. A first protocol may then be fetched from a memory, step 408. In many cases, the first protocol will typically be a protocol prior to any diagnosis being determined. Thus, the first protocol may simply be associated with gathering information necessary to make a diagnosis. In some cases, the patient history may be considered to select a first protocol that is consistent with an already known diagnosis or condition, or the first protocol may be patient customized or the like. The electronic health record is compared to the first protocol, step 410, as the electronic health record is developed. Also, the electronic health record is reviewed in real or near real time to confirm the protocol being used is correct, step 412, explained further below. Typically, the comparison and confirmation would be based on keywords or phrases and would allow for synonyms and alternative words. For example, the doctor may speak the word (or in certain cases the patient may speak the words) “vomit” as part of a diagnosis. The speech to text engine may return the word “emesis,” which is the medical equivalent, or the system may acknowledge that vomit and emesis are synonyms. For example, a general intake may recite the protocol step as take patient's temperature followed by patient's pulse. The health care provider may report temperature 98.6 and pulse 72. Speech to text engine would convert the dictated to textual information that would be input to the electronic health record. The comparison would note the two findings and expect, for example, the next entry to be breath sounds. If, for some reason, the health care provider reported pulse 72 prior to taking the temperature, the recognition engine would identify that the protocol was not being followed, step 414, and may send an alert to the health care provider that the temperature was not taken, step 416. The alert may be a message on the workstation display to the health care provider, an email, a text message, or any number of communication delivery mechanisms. The health care provider can either compensate by taking the temperature in this example, which would be recognized, step 418, or note why the protocol was not followed, step 420. The system may generate metrics based on the above for review by an administrator, step 422. The metrics may include, for example, the number of alerts provided, whether the deviations were explained, whether the explanations were medically reasonable such that the standard of care was not violated, or the like.

Referring now to FIG. 4A, a flowchart 450 is provided with an exemplary method of receiving an electronic health record and confirming in real or near real time the protocol is correct. While flowchart 450 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. For simplicity, flowchart 450 assumes that the protocols are being followed; however, it would be readily apparent on reading the disclosure that the step by step or blocks of steps associated with any particular protocol could be monitored. In any event, the electronic health record is generated, consistent with the above, step 452. The associated protocol is fetched from memory, step 454. The associated protocol may be based on a minimum threshold or confidence level that the protocol corresponds to the patient encounter. In many cases, this first fetched protocol may be a patient intake protocol. The electronic health record is compared to the protocol, step 456. The electronic health record, subsequently, previously, or in conjunction with being compared to the protocol, is analyzed to determine whether another (e.g., one, two or more) protocol(s) should be considered, step 458. For example, while the electronic health record is being developed, the recognition engine may compare the electronic health record to CPT or ICD databases to determine, using keywords or the like, whether other protocols are applicable to the information being entered into the electronic health record. The system may analyze the protocols and determine a priority of which protocol is more consistent with the diagnosis, step 460. The more appropriate protocol would replace the protocol, step 464. In certain embodiments, the health care provider would be alerted that the second protocol is replacing the first protocol, step 462. Once the more appropriate protocol is used to replace the protocol, a check would be performed regarding any protocol steps that may not have been followed in view of the change protocol, step 466. The protocol is fetched from memory and the process repeats until the patient encounter is complete.

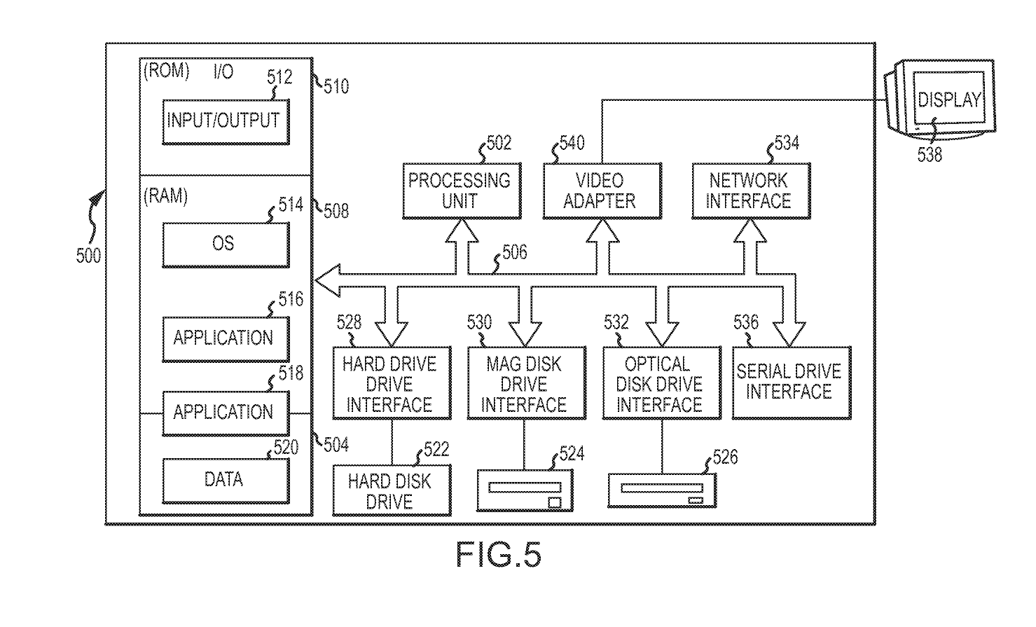

Referring now to FIG. 5, a functional block diagram of a typical workstation 500 for the technology of the present application is provided. Workstation 500 may be any of the above described engines, workstations, servers, or the like. The workstation 500 is shown as a single, contained unit, such as, for example, a desktop, laptop, tablet, handheld, smart phone, personal digital assistant, or mobile processor, but the workstation 500 may comprise portions that are remote and connectable via a network connection such as via a LAN, a WAN, a WLAN, a WiFi Network, Internet, or the like. Generally, the workstation 500 includes a processor 502, a system memory 504, and a system bus 506. The system bus 506, which may follow any conventional protocol such as, for example, PCI or PCI-express, couples the various system components and allows data and control signals to be exchanged between the components. The system memory 504 generally comprises both a random access memory (RAM) 508 and a read only memory (ROM) 510. The ROM 510 generally stores a basic operating information system such as a basic input/output system (BIOS) 512. The RAM 508 often contains the basic operating system (OS) 514, application software 516 and 518, and data 520. The system memory 504 contains the code for executing the functions and processing the data as described herein to allow the present technology of the present application to function as described. The workstation 500 generally includes one or more of a hard disk drive 522 (which also includes flash drives, solid state drives, etc. as well as other volatile and non-volatile memory configurations), a magnetic disk drive 524, or an optical disk drive 526. The drives are connected to the bus 506 via a hard disk drive interface 528, a magnetic disk drive interface 530 and an optical disk drive interface 532. Application modules and data may be stored on a disk, such as, for example, a hard disk installed in the hard disk drive (not shown). The workstation 500 has network connection 534 to connect to a local area network (LAN), a wireless network, an Ethernet, the Internet, or the like, as well as one or more serial port interfaces 536 to connect to peripherals, such as a mouse, keyboard, microphone, touch screen, light pen, modern, or printer. The workstation 500 also may have USB ports or wireless components not shown. Workstation 500 typically has a display or monitor 538 connected to bus 506 through an appropriate interface, such as a video adapter 540. Monitor 538 may be used as an input mechanism using a touch screen, a light pen, or the like. On reading this disclosure, those of skill in the art will recognize that many of the components discussed as separate units may be combined into one unit and an individual unit may be split into several different units. Further, the various functions could be contained in one personal computer or spread over several networked personal computers. The identified components may be upgraded and replaced as associated technology improves and advances are made in computing technology.

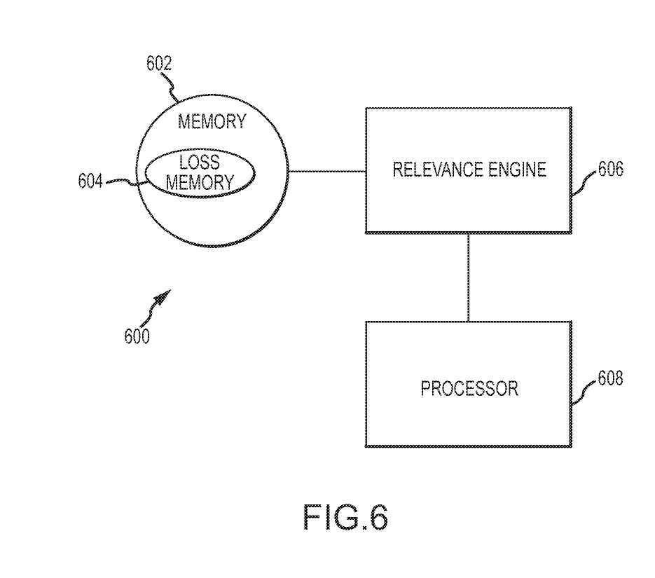

Referring now to FIG. 6, a post patient encounter loss mitigation system 600 is provided. In the above examples, electronic health records are generated and stored. The electronic health records may be stored in a memory 602. Memory 602 may be associated with the workstations (e.g. memory 108), the central hub (e.g. memory 214), or a separate memory as a matter of design choice. Memory 602 would have a database or the like to organize the electronic health records, typically on a patient basis. Certain of the electronic health records may be associated with a loss to the provider group. Those electronic health records would be flagged and, optionally, separately organized in a loss memory 604. Loss memory 604 may be incorporated into memory 602 or a separate stand alone memory. The electronic health records associated with losses may be copied into the loss memory such that duplicate records exist or copied into the loss memory and deleted from the general memory. A relevance engine 606 may be coupled to loss memory 604. The relevance engine 606 would use, for example, a relevance logic system that would review the electronic health records associated with losses and determine potential symmetries and similarities between the files associated with losses. Relevance engine 606 would report symmetries and similarities associated with electronic health records, that experienced losses to a processor 608 that may display, report, or otherwise transmit the information to an administrator or the like that would review the noted information. The administrator would use the information to update the protocols (above) such that the protocols are revised to mitigate the risk and/or provide warnings and/or alerts to the health care provider regarding factors that relate to the noted loss. For example, referring back to FIG. 4 at step 416, the alert may be, for example, a warning such as *** NOTE—FOR A SIMILAR ELECTRONIC HEALTH RECORD, A MALPRACTICE CLAIM WAS FILED BECAUSE THE DOCTOR DID NOT ASK XYZ ***.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for determination of whether a standard of care was provided by a service provider, comprising the steps, performed on at least one processor, of:
receiving at a processor a standardized record of a customer encounter detailing a service provided to the customer;
identifying a standard of care protocol for the service provided to the customer;
automatically comparing by a processor the standardized record of the customer encounter to the standard of care protocol;
determining whether the standardized record for the service provided satisfies the identified standard of care protocol for the service provided; and
if the determination is that the standard of care protocol for the service provided was not satisfied, recording the deficiency.

2. The method of claim 1 wherein the standardized record of the customer encounter is compared to the standard of care protocol in at least one of real time or near real time.

3. The method of claim 2 wherein the receiving step comprises streaming the standardized record.

4. The method of claim 1 further comprises the steps of:
dictating the customer encounter;
converting the dictation to data in a protocol to input to the standardized record; and
populating the standardized record with the data obtained by converting the dictation.

5. The method of claim 2 further comprising:
transmitting an alert to a service provider if the determination is that the standard of care protocol for the service provided was not satisfied.

6. The method of claim 1 where the standardized record is an electronic health record.

7. The method of claim 6 further comprises inputting medical information obtained from the patient encounter into the electronic health record.

8. The method of claim 7 further comprising confirming that the information is within predetermined acceptable values.

9. The method of claim 1 further comprising calculating a compliance score for the service provider based on the recorded deficiencies.

10. An apparatus, comprising:
a workstation, the workstation comprising an interface to generate a standardized service record; and
a hub networked to the workstation, the hub comprising:
a recognition engine, and
a memory, the memory containing at least one standard of care protocol corresponding to the standardized service record;
wherein the workstation receives input data regarding a service encounter to populate the standardized service record with data,
wherein the recognition engine fetches from the memory the at least one standard of care protocol corresponding to the standardized service record and compares the standard of care protocol to the standardized service record, and
wherein the hub generates a report when the recognition engine determines the standardized service record does not satisfy the at least one standard of care protocol.

11. The apparatus of claim 10, wherein the interface comprises at least a microphone to receive audio corresponding to the standardized service record, wherein the workstation is networked to a speech recognition engine that converts the audio to data and populates the standardized service record with the data.

12. The apparatus of claim 10, wherein the workstation streams data captured in the standardized service record to the hub such that the recognition engine can determine whether the standardized service record satisfies the at least one standard of care protocol in one of real or near real time.

13. The apparatus of claim 12 wherein the hub transmits alerts to the workstation when the recognition engine determines the standardized service record does not satisfy the standard of care protocol.

14. The apparatus of claim 10 wherein the standardized service record is an electronic health record.

15. The apparatus of claim 14 wherein the workstation populates the electronic health record by streaming audio from the workstation to a speech to text engine and the speech to text engine converts the stream audio to data and populates the standardized service record with the data.

16. The apparatus of claim 13 wherein the standardized service record contains a justification for deviations from the at least one standard of care protocol.

17. A method for automating determination of whether a medical standard of care was provided by a service provider, comprising the steps of:
generating at a workstation an electronic health record based on notes from a patient encounter provided by a health care provider;
fetching a first standard of care protocol from a memory;
comparing the generated electronic health record to the first, fetched standard of care protocol;
determining whether a second standard of care protocol corresponds to the electronic health record based;
prioritizing the first standard of care protocol and the second standard of care protocol based on the electronic health record;
substitute the second standard of care protocol for the first standard of care protocol when the second standard of care protocol is determined to be of a higher priority; and
alerting the health care provider when the substitution occurs.

18. The method of claim 17 wherein the prioritizing comprises analyzing the electronic health record to at least one of the Current Procedural Terminology database (CPT) or the International Statistical Classification of Diseases and Related Health Problems database (ICD).

19. The method of claim 17 further comprising comparing the generated electronic health record to the second standard of care protocol after the substitution.
